(19) United States
(12) Patent Application Publication
(10) Pub. No.: US 2008/0085408 A1
(43) Pub. Date: Apr. 10, 2008

(54) Coated polyester film with high surface tension and low coefficient of friction

(76) Inventors: Matthias KONRAD, Hofheim (DE); Martin JESBERGER, Mainz (DE); Gottfried HILKERT, Saulheim (DE)

Correspondence Address: PROPAT, L.L.C., 425-C SOUTH SHARON AMITY ROAD, CHARLOTTE, NC, 28211-2841, US

(21) Appl. No.: 11/743,233

(22) Filed: May 2, 2007

(30) Foreign Application Priority Data
May 4, 2006 (DE) 10 2006 020 712.2

(51) Int. Cl. B32B 27/36; B32B 27/30; C09J 7/02; C08J 7/04; B05D 7/00; B32B 9/04

(52) U.S. Cl. 428/337; 428/480; 428/447; 428/522; 428/341; 427/412.1

(57) ABSTRACT

The invention relates to a coated polyester film with high surface tension and very low coefficient of friction. These properties are achieved using a polymeric coating in which the polymer contains both hydrophilic and hydrophobic sections.

### CROSS-REFERENCE TO RELATED APPLICATIONS

This application claims priority to German Patent Application 10 2006 020 712.2 filed May 4, 2006 which is hereby incorporated herein by reference in its entirety.

### FIELD OF THE INVENTION

The invention relates to a coated polyester film with high surface tension and very low coefficient of friction. These properties are achieved using a polymeric coating in which the coating polymer contains both hydrophilic and hydrophobic sections.

### BACKGROUND OF THE INVENTION

Industry has a high requirement for polyester films which firstly have good slip properties and secondly have high surface tension. The slip properties are, by way of example, important for permitting good separation or removal from a stack of individual sheets of film. The high surface tension improves, by way of example, the printability of the film, this being particularly important when water-based inks are used.

High surface tensions of films (with respect to water), i.e. hydrophilic properties, can be achieved by various methods. Corona- or plasma-treatment can raise the surface tension of polyester film to greater than 50 mN/m, while that of an untreated polyester film is 43 mN/m. The use of coatings can lead to very high surface tensions of up to 70 mN/m.

Low coefficients of friction are obtained, by way of example, via addition of certain additives, e.g. large particles, to the polyester, or else via a coating. Very low coefficients of friction are obtained in films with coatings which comprise silicone or wax. However, these coatings lead to low surface tension of the film.

There has hitherto been no known polyester film which simultaneously has high surface tension and very low coefficients of friction.

Hydrophilic coatings based on water-soluble polymers are known. Surfactants are also used for hydrophilic antifog coatings, since they reduce the surface tension of water.

U.S. Pat. No. 4,467,073 discloses a transparent antifog coating. The composition comprises a) polyvinylpyrrolidone, polydimethylacrylamide, or a polyvinylpyrrolidone copolymer with an α-olefin, b) a polyisocyanate prepolymer, c) a surfactant, and d) an organic solvent. The disadvantage of this coating composition is the use of an organic solvent, specifically if the intention is to integrate the coating step into film production (in-line). Another disadvantage is the hardening time described of 24 hours and longer, which adversely affects cost-effectiveness.

U.S. Pat. No. 5,262,475 describes a hydrophilic composition which comprises polyvinylpyrrolidone, polyvinyl alcohol, and, as crosslinking agent, melamine, a mineral acid, or a strong organic acid. The coating solution can moreover comprise additives, such as chain extenders, foam regulators, or surfactants. The solids content of the coating is from 5 to 50% by weight. Crosslinking to give hard clear layers requires temperatures of at least 75° C., and temperatures of from 130 to 150° C. are used in the examples. With this, these coatings are unsuitable for in-line application to polyester films, since the components crosslink before the drying or stretching process has ended, and the coating therefore splits and thus may lead to break-offs of the film. Another factor that makes the crosslinked coatings appear unsuitable for use on flexible substrates is that they are described as hard.

In-line siliconization of polyester film is described, by way of example, in EP-B-0 536 766. Although these films have a low coefficient of friction they simultaneously also have very low surface tension and do not therefore meet the relevant requirements. Another disadvantage is that the coatings mentioned are reactive systems and therefore have to be processed rapidly.

### SUMMARY OF ADVANTAGEOUS EMBODIMENTS OF THE INVENTION

It was an object of the present invention to provide a polyester film which features not only high surface tension, greater than 53 mN/m, but also low coefficients of friction. The coefficient of static friction is intended to be smaller than or equal to 0.25 and the coefficient of sliding friction is intended to be smaller than or equal to 0.2.

### BRIEF DESCRIPTION OF THE DRAWINGS

FIG. 1 schematically illustrates an exemplary contact angle of water on a film surface.

### DETAILED DESCRIPTION OF ADVANTAGEOUS EMBODIMENTS OF THE INVENTION

This object is achieved via a biaxially oriented polyester film which has been coated with a polymer which contains both hydrophilic and hydrophobic sections.

The coating polymer is preferably a polydiogranosiloxane of the formula (I)

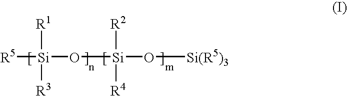

in which
R² and R⁴ are identical or different and are —(R⁶—O)₂—H, —(R⁶—O)_{q}—C(O)—CR⁵═CH₂, —(R⁶—C(O)O)_{q}—H, C₁-C₆-alykl acrylate, C₁-C₈-alkyl methacrylate, poly (C₁-C₆)-alkyl acrylate, poly (C₁-C₆)-alkyl methacrylate, —R⁶—OH, —R⁶—NH₂, —R⁶—NH—C(O)—R⁵, or R⁵, and
R¹ and R³ are identical or different and are a linear or branched C₁-C₆-alkyl, preferably C₁-C₆-alkyl, particularly preferably C₁-C₃-alkyl, radical, or are defined as for R² and R⁴, and
R⁵ is a linear or branched C₂-C₈-alkyl, preferably C₁-C₆-alkyl, particularly preferably C₁-C₃-alkyl, radical, and
R⁶ is a linear or branched C₁-C₃₈-alkylene, preferably C₂-C₁₉-alkylene, particularly preferably C₂-C₆-alkylene, radical, and
n and m are, independently of one another, a number from 5 to 1000, preferably from 10 to 500, particularly preferably from 20 to 100, and the sum of n and m is a number from 10 to 100 000, preferably from 100 to 50 000, particularly preferably from 1000 to 10 000, and
q is a number from 10 to 10 000, preferably from 100 to 5000, particularly preferably from 200 to 3000,
   or a polyacrylate of the formula (II)

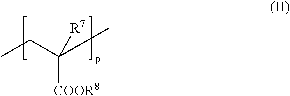

in which
R⁸ is

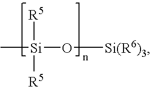

where R⁵ are identical or different, and, like n, are as defined above,
R⁷ is a H or CH₃, and
p is a number from 10 to 100 000, preferably from 100 to 50 000, particularly preferably from 1000 to 10 000.

Preference is given to polymers of the formula (I) where the substituents are defined as follows:
R² and R⁴ are identical or different and are —(R⁶—O)_{q}—H, —(R⁶—O)_{q}—C(O)—CR⁵═CH₂, —R(R⁶—C(O)O)_{q}—H, C₁-C₃-alkyl acrylate, C₁-C₃-alkyl methacrylate, poly(C₁-C₃)-alkyl acrylate, poly(C₁-C₃)-alkyl methacrylate, —R⁶—OH, or R⁵,
   where R⁵ is a linear or branched C₁-C₃-alkyl radical,
   R⁶ is a linear or branched C₂-C₆-alkylene radical, and
   q is a number from 100 to 5000,
R¹ and R³ are identical or different and are a linear or branched C₁-C₃-alkyl radical, and
the sum of n and m is a number from 100 to 50 000.

Particular preference is given to polymers of the formula (I) where the substituents are defined as follows:
R² and R⁴ are identical or different and have been selected either from
   —(R⁶—O)_{q}—H, C₁-C₃-alkyl acrylate, C₁-C₃-alkyl methacrylate, poly(C₁-C₃-alkyl acrylate, poly(C₁-C₃) alkyl methacrylate and (R⁵)₃—Si—
   or —(R⁶—O)_{q}—H, —(R⁶—C(O)O)_{q}—H, R⁶—OH and (R⁵)₃—Si—
   where R³ is a linear or branched C₁-C₃-alkyl radical,
   R⁶ is a linear or branched C₂-C₆-alkylene radical, and
   q is a number from 100 to 5000,
R¹ and R³ are identical and are a methyl radical.

By way of example, therefore, the coating polymer is a polydialkylsiloxane having functional groups, e.g. (poly)ethers, (poly)esters, (poly)acrylates, alcohols, carboxylic acids, amines, or amides, or is a silicone-modified. OH-functional polyacrylate. It is preferable to use a polyether-, polyester-, acrylic- and/or hydroxy-modified polydimethyl-, polydialkyl-, or polymethylalkyl-siloxane. Particular reference is given to a polyether-modified, acrylic-functional polydimethylsiloxane, or a polyether-polyester-modified, hydroxy-functional polydimethylsiloxane.

For application to the inventive film, the coating polymer is dissolved in a solvent, preferably water. The concentration of the coating polymer in the coating solution is—as a function of the coating technology used—from 0.5 to 5.0% by weight, preferably from 1.0 to 4.0% by weight, particularly preferably from 1.5 to 3.5% by weight (always based on the weight of the coating solution).

Optionally, the coating solution can comprise inorganic and/or organic particles, e.g. calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, titanium dioxide, kaolin, or crosslinked polystyrene particles, or crosslinked acrylate particles. The median diameter (d₅₀) of these particles is advantageously from 0.05 to 3.0 μm, preferably from 0.15 to 2.5 μm, and particularly preferably from 0.15 to 2.0 μm. If these particles are used, their amount present in the coating solution is from 0.05 to 2.0% by weight, preferably from 0.1 to 1.4% by weight, particularly preferably from 0.1 to 1.0% by weight (always based on the weight of the coating solution).

Optionally, the coating can also comprise a polymer or oligomer which improves the binding of the other components to the polyester surface (adhesion-promoting polymer). These polymers are preferably used in the form of aqueous solution or dispersion. Examples of suitable polymers of this type are acrylates as described, by way of example, in WO 94/13476, polyurethanes, butadiene copolymers with acrylonitrile or methyl methacrylate, methacrylic acid, or an ester thereof. Examples of suitable oligomers are aminosiloxanes, which are used in the form of dispersion which can be prepared in situ from aminosilanes. If these adhesion-promoting polymers are used, their amount present in the coating solution is from 0.5 to 5.0% by weight, preferably from 0.5 to 4.0% by weight, particularly preferably from 0.5 to 3.0% by weight (always based on the weight of the coating solution).

Surprisingly, the coating of polyester film with the polymers of formula (I) and/or (II) leads to high surface tension, i.e. leads surprisingly to a hydrophilic surface, and to a very low coefficient of friction. This is particularly surprising because the polymers mentioned are known to improve the cleanability of a coating by hydrophobicizing the surface, i.e. actually bringing about an effect opposite to that which is achieved in the present invention.

The surface tension of the film is greater than or equal to 53 mN/m.

The coefficient of static friction of the coated side of the film with respect to the uncoated side is smaller than or equal to 0.25.

The coefficient of sliding friction of the coated side of the film with respect to the uncoated side is smaller than or equal to 0.2.

The dry weight of the coating is from 0.01 to 0.3 g/m².

### Backing Film

The backing film for the coating preferably comprises at least 70% by weight of thermoplastic polyester. Materials suitable for this purpose are polyesters comprised of ethylene glycol and terephthalic acid (=polyethylene terephthalate, PET), comprised of ethylene glycol and naphthalene-2,6-dicarboxylic acid (=polyethylene-2,6-naphthalate, PEN) comprised of 1,4-bishydroxymethylcyclohexane and terephthalic acid (=poly(1,4-cyclohexanedimethylene terephthalate), PCDT) or else of ethylene glycol, naphthalene-2,6-dicarboxylic acid and biphenyl-4,4′-dicarboxylic acid (=polyethylene-2,6-napthalata bibenzoate, PENBB). Particular preference is given to polyesters comprised of at least 90 mol %, preferably at least 95 mol %, of ethylene glycol units and terephthalic acid units, or of ethylene glycol units and of naphthalene-2,6-dicarboxylic acid units. In a preferred embodiment, the backing film is comprised of at least 90% by weight of polyethylene terephthalate. The remaining proportions derive from other aliphatic, cycloaliphatic, or aromatic diols and, respectively, dicarboxylic acids.

Other examples of suitable aliphatic diols are diethylene glycol, triethylene glycol, aliphatic glycols of the formula HO—(CH₂)ₙ—OH, where n is an integer from 3 to 6 (in particular 1,3-propanediol, 1,4-butanediol, 1,5-pentanediol and 1,6-hexanediol) or branched aliphatic glycols having up to 6 carbon atoms. Among the cycloaliphatic diols, mention should be made of cyclohexanediols (in particular 1,4-cyclohexanediol). Examples of other suitable aromatic diols have the formula HO—C₆H₄—X—C₆H₄—OH, where X is —CH₂—, —C(CH₃)₂—, —C(CF₃)₂—, —O—, —S— or —SO₂—. Bisphenols of the formula HO—C₆H₄—C₆H₄—OH are also very suitable.

Other aromatic dicarboxylic acids are preferably benzenedicarboxylic acids, naphthalenedicarboxylic acids, such as naphthalene-1,4- or -1,6-dicarboxylic acid, biphenyl-x,x′-dicarboxylic acids, in particular biphenyl-4,4′-dicarboxylic acid, diphenylacetylene-x,x′-dicarboxylic acids, in particular diphenylacetylene-4,4′-dicarboxylic acid, or stilbene-x,x′-dicarboxylic acids. Among the cycloaliphatic dicarboxylic acids mention should be made of cyclohexanedicarboxylic acids, in particular cyclohexane-1,4-dicarboxylic acid. Among the aliphatic dicarboxylic acids, the (c₃ to C₁₉) alkanediacids are particularly suitable, and the alkane moiety here may be straight-chain or branched.

One way of preparing the polyesters is the transesterification process. Here, the starting materials are dicarboxylic esters and diols, which are reacted using the customary transesterification catalysts, such as the salts of zinc, of calcium, of lithium, of magnesium or of manganese. The intermediates are then polycondensed in the presence of well-known polycondensation catalysts, such as antimony trioxide or titanium salts. Another equally good preparation method is the direct esterification process in the presence of polycondensation catalysts. This starts directly from the dicarboxylic acids and the diols.

The thickness of the backing film can vary widely. It is advantageously in the range from 10 to 350 μm, in particular from 10 to 300 μm, preferably from 10 to 250 μm.

The backing film to which the coating is applied can—as describer—be a single-layer film, but can also be a two-layer film comprised of a base layer (B) and of an outer layer (A), or a three-layer film comprised of a base layer (B) and of two outer layers (A) and (A′ or C). The additional layers needed for the multilayer structure can be manufactured from polyesters identical with those described above for the backing film.

The backing film can be transparent, white, opaque, glossy, or matt. These various optical properties are achieved, by way of example, via addition of different amounts of additives, e.g. calcium carbonate, amorphous silica, or titanium dioxide. These additives can be present not only in the base layer (in the case of single- or multilayer films) but also in any outer layers that may be present in a multilayer film.

### Production Process

The invention also provides a process for production of the inventive polyester film by the extrusion process known from the literature (“Handbook of Thermoplastic Polyesters, Ed. S. Fakirov, Wiley-VCH, 20002” or in the chapter “Polyesters, Films” in the “Encyclopedia of Polymer Science and Engineering”, vol. 12, John Wiley & Sons, 1988”).

First, as is conventional in the extrusion process, the polymer or the polymer mixture for the film is compressed and plastified in an extruder, and by this stage the polymer or the polymer mixture may comprise any additives that may have been provided. The melt is then extruded through a flat-film die, and the extruded melt is drawn off on one or more cooled take-off rolls, whereupon the melt cools and solidifies to give a prefilm. In the case of a multilayer film, the polymers of the individual layers are melted and brought together in a coextrusion die and then extruded in the form of a multilayer prefilm from the flat-film die.

Biaxial stretching is generally carried out sequentially. In this, the prefilm is preferably first stretched longitudinally (i.e. in machine direction=MD and then transversely (i.e. perpendicularly to machine direction=TD). This leads to spatial orientation of the polymer chains. The longitudinal stretching can be carried out with the aid of two rolls rotating at different speeds, corresponding to the desired stretching ratio. For transverse stretching, an appropriate tenter frame is usually used, in which both edges of the film are clamped and then drawn toward the two sides at an elevated temperature.

The temperature at which the stretching is carried out can vary relatively widely and is a function of the desired properties of the film. Longitudinal stretching is generally carried out at a temperature in the range from 80 to 130° C. and transverse stretching in the range from 90 to 150° C. The longitudinal stretching ratio is generally in the range from 2.5:1 to 5:1, preferably from 3:1 to 4.5:1. The transverse stretching ratio is generally in the range from 3.0:1 to 5.0:1, preferably from 3.5:1 to 4.5:1.

In the heat-setting that follows, the film is kept for a period of about 0.1-10 s, at a temperature in the range from 150 to 250° C. The film is then conventionally wound.

After biaxial stretching, the uncoated surface of the film can be corona- or flame-treated by one of the known methods. The intensity of treatment is adjusted so as to give surface tension in the range above 45 mN/m.

### Coating

The inventive coating is advantageously applied during the film-production process prior to transverse stretching. In order to achieve good wetting of the polyester film with the preferably aqueous solution, the surface is preferably first corona-treated. The coating can then be applied by any familiar suitable process, for example with a slot coater or by a spray method. It is particularly preferable to apply the coating by means of reverse gravure-roll coating (see Adhasion [Adhesion], 1977, 189 et. seq., Hugo Klein), a process which can apply the coating extremely homogeneously with application weights of from 1.0 to 5 g/m². Preference is also given to application via the Meyer-Rod process (see E. D. Cohen, E. G. Gutoff, Coating Process Survey, Kirk Othmar Encyclopedia of Chemical Technology, 5th Ed., John Wiley & Sons, Inc. N.Y., 2002), which can achieve relatively high coating thicknesses. The dry weights of the coating on the finished film are from 0.01 to 0.3 g/m², preferably from 0.01 to 0.25 g/m².

It has been ensured that, during production of the inventive film, an amount in the range up to 70% by weight, based on the total weight of the film, of the out material (regrind) can be reintroduced to the extrusion process, without any significant resultant adverse effect on the physical properties of the film, and in particular its appearance.

The table below (table 1) once again collates the most important inventive properties of the polyester film.

TABLE 1

| | | | very | |
|---|---|---|---|---|
| | | particularly | particularly | |
| | preferred | preferred | preferred | Unit |
| Surface | >53 | >54 | >55 | mN/m |
| tension | | | | |
| Coefficient | <0.25 | <0.22 | <0.20 | |
| of static | | | | |
| friction | | | | |
| Coefficient | <0.20 | <0.18 | <0.16 | |
| of sliding | | | | |
| friction | | | | |
| Dry weight | 0.01–0.3 | 0.01–0.25 | 0.01–0.1 | g/m² |
| of coating | | | | |

The following methods were used in tests to characterize the properties of the polyester films:

### Surface Tension

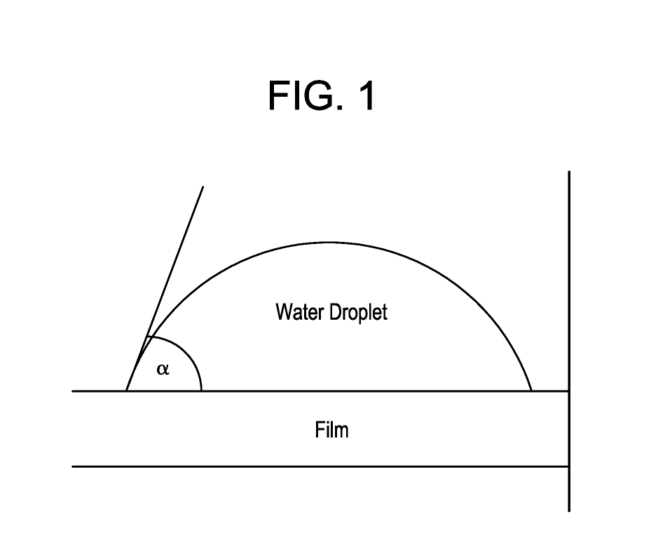

The surface tension of the film was measured by the contact angle method. The contact angle α with respect to water (see FIG. 1) was measured and was taken as a measure of the level of hydrophilic properties/surface tension of the film surface. The smaller the contact angle α, the higher the level of hydrophilic properties/surface tension of the film surface. A Gl goniometer from Kruss, Hamburg, Germany, was used for the measurement.

### Coefficient of Friction

The coefficient of friction was determined to DIN 53375. The coefficient of sliding friction was measured 14 days after production.

### SV Value (standard viscosity)

Standard viscosity SV (DCA) is measured by a method based on DIN 53726, at 20° C. in dichloracetic acid. Intrinsic viscosity (IV, measured in dl/g) of polyethylene terephthalate is calculated as follows from standard viscosity

IV=[π]=6.907·10⁻⁴ SV (DCA)+0.063096 [dl/g]

### Median Particle Diameter d₅₀

Median diameter d₅₀ was determined on a Horiba LA 500 (Horiba Europe GmbH, Germany). The particular size analyzer is based on the principle of elastic laser scattering at dispersed principle of elastic laser scattering at dispersed particles. Dispersions in ethylene glycol were used to measure the particles. To produce the dispersions, the particles were stirred into ethylene glycol, lightly ground and then treated with ultrasound. The test procedure is automatic and also includes mathematical determination of the d₅₀ value. The d₅₀ value is defined here as being determined from the (relative) cumulative particle size distribution curve: the intersection of the 50% ordinate value with the cumulative curve provides the desired d₅₀ value (dᵥ voluminal median) on the abscissa axis. Examples are used below for further illustration of the invention.

### Example 1

The following components were dissolved in water to produce the coating solution:
3.0% by weight of polyether-modified acrylic-functional polydimethylsiloxane (BYK-SILCLEAN® 3710, BYK-Chemie GmbH, Wesel, DE)

A melt was produced from polyethlene terephthalate (grade 4023, Invista, DE), and this was extruded through a flat-film die onto a casting roll kept at about 20° C., where it solidified to give an unoriented film of thickness 160 μm. The unoriented film was longitudinally stretched with a stretching ratio of 3.8:1, being kept at a temperature of 115° C. The longitudinally stretched film was corona-treated in corona-discharge equipment (55 mN/m) and then coated (2 g/m²) with the solution described above comprised of polyether-modified acrylic-functional polydimethylsiloxane, via reverse-gravure coating (cell volume about 6 cm³/m²). The longitudinally stretched, corona-treated, coated film was dried at a temperature of 100° C. The film was then transversely stretched with a stretching ratio of 3.8:1, giving a biaxially stretched film. The biaxially stretched film was heat-set at 230° C. The final film thickness was 12 μm. The dry weight of the coating was about 0.015 g/m².

The film exhibited very low coefficients of friction and high surface tension (see table 2).

### Example 2

A polyester film was produced as in Example 1, except the coating solution used was as follows:
2.0% by weight of polyether-modified acrylic-functional polydimethylsiloxane (BYK-SILCLEAN® 3710, BYK-Chemie GmbH, Wesel, DE)
1.0% by weight of acrylate copolymer, comprised of 60% by weight of methyl methacrylate, 35% by weight of ethyl acrylate and 5% by weight of n-methylolacrylamide
97% by weight of water.

The dry weight of the coating was about 0.02 g/m², the thickness of the backing film being 23 μm.

As in example 1, this film also exhibited very low coefficients of friction and high surface tension. In comparison with example 1, there was an improvement in the adhesion of the coating on the film.

### Example 3

A polyester film was produced as in Example 1, except using the following coating solution:
3.0% by weight of polyether-modified acrylic-functional polydimethylsiloxane (BYK-SILCLEAN® 3710, BYK-Chemie GmbH, Wesel, DE)
1.0% by weight of silicon dioxide (Nalco 1030, US)
96% by weight of water

The dry weight of the coating was about 0.06 g/m², the thickness of the backing film being 50 μm.

As in example 1, this film also exhibited very low coefficients of friction and high surface tension. In comparison with example 2, there was a reduction in the coefficient of friction of the film.

TABLE 2
Film properties

| | Example 1 | Example 2 | Example 3 |
|---|---|---|---|
| Surface tension | 58 mN/m | 56 mN/m | 57 mN/m |
| Coefficient of | 0.20 | 0.22 | 0.21 |
| static friction | | | |
| Coefficient of | 0.16 | 0.18 | 0.17 |
| sliding friction | | | |

Patent claims:

1. A biaxially oriented polyester film comprising a coating polymer comprising both hydrophilic and hydrophobic sections.

2. The polyester film as claimed in claim 1, wherein the coating polymer is a polydiorganosiloxane of the formula (I) 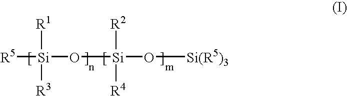
in which
R² and R⁴ are identical or different and are —(R⁶—O)_{q}—H, —(R⁶O)_{q}—C(O)—CR⁵═CH₂, —(R⁶—C(O)O)_{q}—H, C₁-C₆-alkyl acrylate, C₁-C₅-alkyl methacrylate, poly(C₁-C₅)-alkyl acrylate, poly(C₁-C₆)-alkyl methacrylate, —R⁶—OH, —R⁶—NH₂, —R⁶—NH—C(O)—R⁵, or R⁵, and
R^{1 and R}³ are identical or different and are a linear or branched C₁-C₈-alkyl radical, or are defined as for R² and R⁴, and
R⁵ is a linear or branched C₁-C₈-alkyl radical, and
R⁶ is a linear or branched C₁-C₁₈-alkylene radical, and
n and m are, independently of one another, a number from 5 to 1000, and the sum of n and m is a number from 10 to 100 000, and
q is a number from 10 to 10 000, or a polyacrylate of the formula (II) 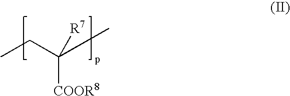
in which
R⁸ is 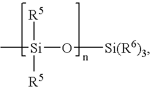
where R⁵ are identical or different, and, like n, are as defined above,
R⁷ is H or CH₃, and
p is a number from 10 to 100 000.

3. The polyester film as claimed in claim 1, wherein the coating polymer is
a) a polydialkylsiloxane having functional groups, where the functional groups are selected from: (poly)ethers, (poly)esters, (poly)acrylates, alcohols, carboxylic acids, amines, and amides, or
b) a silicone-modified, OH-functional polyacrylate, or
a mixture comprising a) and b).

4. The polyester film as claimed in claim 1, wherein the coating polymer comprises inorganic and/or organic particles.

5. The polyester film as claimed in claim 4, wherein the median diameter (d₅₀) of the particles is from 0.05 to 3.0 μm.

6. The polyester film as claimed in claim 1, said film having a surface tension of greater than or equal to 53 mN/m.

7. The polyester film as claimed in claim 1, wherein the coefficient of static friction of the coated side of the film with respect to the uncoated side is smaller than or equal to 0.25.

8. The polyester film as claimed in claim 1, wherein the coefficient of sliding friction of the coated side of the film with respect to the uncoated side is smaller than or equal to 0.2.

9. The polyester film as claimed in claim 1, wherein the dry weight of the coating polymer on the film is from 0.01 to 0.3 g/m².

10. The polyester film as claimed in claim 1, wherein the thickness of the polyester film is in the range from 10 to 350 μm.

11. The polyester film as claimed in claim 1, wherein said film is a one-layer film.

12. The polyester film as claimed in claim 1, wherein said film is a multilayer film.

13. The polyester film as claimed in claim 1, wherein said film is transparent, white, or opaque.

14. The polyester film as claimed in claim 1, wherein said film is glossy or matt.

15. A process for producing a film as claimed in claim 1 comprising compressing and plastifying the polymer or the polymer mixture for the film in an extruder and extruding the polymer or polymer mixture through a flat-film die to form extruded melt, drawing off the extruded melt on one or more cooled take-off rolls, whereupon the melt cools and solidifies to give a prefilm, sequentially biaxially orienting the prefilm in machine direction and transverse directions, heat-setting the oriented film, and winding up the heat-set film, wherein, during the sequential orientation process, the film is coated with a coating polymer which comprises both hydrophilic and hydrophobic sections.

16. A process comprising printing a film as claimed in claim 1.

17. A process as claimed in claim 16, wherein said process prints with water-based inks.

18. The polyester film as claimed in claim 1, wherein
R¹ and R³ are identical or different and are a linear or branched C₁-C₅-alkyl radical, and
R⁵ is a linear or branched C₁-C₆-alkyl radical, and
R⁶ is a linear or branched C₂-C₁₀-alkylene radical, and
n and m are, independently of one another, a number from 10 to 500, and
q is a number from 100 to 5000, and
p is a number from 100 to 50 000.

19. The polyester film as claimed in claim 1, wherein
R¹ and R³ are identical or different and are a linear or branched C₁-C₃-alkyl radical, and
R⁵ is a linear or branched C₁-C₃-alkyl radical, and
R⁶ is a linear or branched C₂-C₆-alkylene radical, and
n and m are, independently of one another, a number from 20 to 100, and
q is a number from 200 to 3000, and
p is a number from 1000 to 10 000.
